(19) United States
(12) Patent Application Publication
(10) Pub. No.: US 2022/0342113 A1
(43) Pub. Date: Oct. 27, 2022

(54) ESTIMATION OF PROPERTIES OF A SUBTERRANEAN REGION USING A SYNTHETIC PHYSICAL MODEL

(71) Applicants: Umesh Prasad, Spring, TX (US); Marc Bird, Houston, TX (US); Jeffrey Honekamp, Tomball, TX (US); Anjani Achanta, Houston, TX (US)

(72) Inventors: Umesh Prasad, Spring, TX (US); Marc Bird, Houston, TX (US); Jeffrey Honekamp, Tomball, TX (US); Anjani Achanta, Houston, TX (US)

(73) Assignee: Baker Hughes Oilfield Operations LLC, Houston, TX (US)

(21) Appl. No.: 17/236,429

(22) Filed: Apr. 21, 2021

(51) Int. Cl. G01V 99/00; G06F 30/10; B33Y 50/02; B28B 17/00; B28B 1/00

(52) U.S. Cl. CPC G01V 99/005; G06F 30/10; B33Y 50/02; B28B 17/0081; B28B 1/001; G06F 2113/10

(57) ABSTRACT

A method of estimating a property associated with a subterranean region includes acquiring a synthetic physical model of the subterranean region, the physical model made from at least a mineral material and constructed using an additive manufacturing process, the physical model having a microstructure, the microstructure having a parameter that varies along at least a first axis of the physical model. The method also includes performing a measurement of the physical model under an applied condition, and estimating the property of the subterranean region based on the measurement.

### BACKGROUND

In hydrocarbon exploration and energy industries, evaluation of subterranean hydrocarbon reservoirs is accomplished using various techniques for measuring formation properties. Mechanical properties of a formation material can be derived from surface measurements of cores and/or from downhole log measurements. The knowledge of mechanical and other properties of subsurface formations is important in many applications, including surface and downhole operations.

Estimations or predictions of mechanical properties are important in applications such as drilling, drill bit design, borehole stability analysis, fracturing operation design, subsidence analysis, and sand production prediction. For example, properties of downhole material (e.g., rock) can be estimated from log measurements calibrated with results of laboratory testing of core plugs.

### SUMMARY

An embodiment of a method of estimating a property associated with a subterranean region includes acquiring a synthetic physical model of the subterranean region, the physical model made from at least a mineral material and constructed using an additive manufacturing process, the physical model having a microstructure, the microstructure having a parameter that varies along at least a first axis of the physical model. The method also includes performing a measurement of the physical model under an applied condition, and estimating the property of the subterranean region based on the measurement.

An embodiment of a method of manufacturing a physical model of a subterranean region includes acquiring model materials including at least a mineral material, designing a digital model of the subterranean region, the digital model specifying a microstructure having a parameter that varies along at least a first axis of the digital model, and constructing the physical model by an additive manufacturing process according to specifications of the physical model.

### BRIEF DESCRIPTION OF THE DRAWINGS

The following descriptions should not be considered limiting in any way. The following descriptions reference the accompanying drawings:

FIG. 1 depicts aspects of an embodiment of a method of manufacturing a synthetic physical model of a subterranean region and/or estimating properties thereof;

FIG. 2 depicts an example of a physical model and microstructural features of the model;

FIG. 3 depicts an example of a physical model configured to simulate a core sample of a subterranean region, including vertical model layers configured to exhibit anisotropy;

FIG. 4 depicts an example of a physical model configured to simulate a core sample of a subterranean region, including horizontal model layers;

FIG. 5 is a graph depicting results of seismic measurements (e.g., logging measurements in the field and/or ultrasonic tests at a surface location) of the physical model of FIG. 3, including measured compressional wave velocities;

FIG. 6 is a graph depicting results of seismic measurements (e.g., logging measurements in the field and/or ultrasonic tests at a surface location) of the physical model of FIG. 3, including measured shear wave velocities; and

FIG. 7 depicts an embodiment of a processing system configured to perform aspects of one or more methods described herein.

### DETAILED DESCRIPTION

Devices, systems and methods are provided for manufacturing a synthetic physical model of subterranean region, and/or estimating a property or properties of a subterranean region using a synthetic physical model. The model is configured to approximate various materials and structures that may be found in a subterranean region.

A subterranean region may include one or more rock materials (also referred to as rocks), a combination of multiple rock materials, or a combination of one or more rock materials and other substances encountered downhole. Such other substances include fluids such as hydrocarbon fluids, non-hydrocarbon fluids (e.g., water), hydrocarbon gases and non-hydrocarbon gases. A rock material or rock may be composed of one or more minerals (e.g., quartz and/or feldspar in sandstone rocks).

The physical model may be constructed to have physical characteristics or parameters (e.g., selected material and/or mechanical properties) that correspond to expected, speculative or known features of a given subterranean region. For example, the physical model can simulate or approximate conventional reserves with ranges in porosity, and regions (e.g., unconventional reserves) with layering, anisotropy (e.g., transverse isotropy) and/or orthotropy. It is noted that the physical characteristics are not limited to those that correspond to a specific subterranean region; one or more physical characteristics may be imparted to the model independent of any specific region.

Embodiments include a method of manufacturing a synthetic physical model of a formation material in a subterranean region using an additive manufacturing process, such as three-dimensional (“3D”) printing. Additive manufacturing processes construct a three-dimensional object by successively adding individual layers of material to gradually build up the object in three dimensions.

The physical model is made from a material or combination of materials that have selected mechanical properties. The selected mechanical properties may be the same as, or similar to, mechanical properties of rocks expected or known to be encountered in a subterranean region, e.g., as a result of a downhole operation.

The physical model may be produced using various materials, such as polymer, metal, ceramic and others. In an embodiment, the physical model is made using rock or rock-like material, such as gypsum, ceramic, silica and/or other mineral materials. A “rock-like material” is any material or combination or materials that, when incorporated into the physical model, approximate subterranean rock. A “mineral material” as described herein may be a single mineral or a combination of minerals.

In an embodiment, the material used to create the physical model is a granular rock-like or mineral material, such as gypsum powder. The gypsum powder may be combined with a binder or other material as part of a process of manufacturing the model.

The physical model may be manufactured to have selected material properties such as mineral content, have structural features such as pores and fractures, and/or have mechanical properties such as elasticity and strength. For example, a 3D printing process or other suitable process is used to manufacture the physical model based on a digital model (e.g., a computer-aided design model).

In an embodiment, the physical model is manufactured to have one or more selected properties that vary within the physical model. For example, properties such as porosity, pore structure, fracture properties and material properties are varied along one or more directions (e.g., axes of the model geometry) to simulate anisotropy. and/or features of the model microstructural properties and/or other properties are varied along a given direction or directions. The properties may be varied in a gradual manner, in discrete steps (e.g., to simulate bedding layers) and/or by incorporating features such as fractures or cracks.

In an embodiment, the physical model is constructed to include microstructural features. Microstructural features include pores, grains, cracks, fractures and/or other features that have a scale on the order of microns. Parameters of the microstructural features may be controlled and/or varies to simulate a region and may be configured to impart anisotropy to the model. Examples of microstructural parameters include pore size, pore shape, grain size, pore distribution and properties of microfractures, also referred to as microcracks.

As noted above, the physical model may be constructed with controlled physical characteristics in order to impart isotropy, anisotropy and/or orthotropy thereto. The physical model can be printed or otherwise manufactured to vary selected properties along one or more axes, in order to simulate anisotropic and/or orthotropic properties. Isotropic and/or orthotropic properties may be produced by varying material properties (e.g., proportion of a mineral in the material) along a selected direction, mechanical properties and structural features.

For example, the physical model may include one or more planar regions (also referred to as model layers) having selected thicknesses and orientations, where at least one of the model layers has a different physical characteristic (or characteristics) than at least one other model layer. For example, a model layer may have a selected porosity and/or have microstructural features that are different than another model layer. The model layers may be configured to simulate bedding layers that exhibit transverse isotropy, such as vertical transverse isotropy (VTI) or horizontal transverse isotropy (HTI). Although the planar regions as described below are flat (i.e., bounded by flat planes), the planar regions may not be entirely flat (i.e., the boundaries of the planar regions may extend along various axes).

The physical model can be used in various applications, including formation evaluation, analysis of mechanical properties, flow analysis, simulations of drilling and production, and use of the model to design drill bits and/or other cutting tools. For example, various environmental conditions can be applied to the physical model (e.g., temperature, pressure, fluid conditions) and measurements performed thereon, to evaluate the behavior of the physical model in downhole conditions. In another example, a cutting tool or device (e.g., a drill bit or mill) is operated on the physical model to provide information useful in planning and/or controlling downhole drilling and/or milling operations.

Embodiments described herein provide a number of advantages. For example, the use of mineral material and/or other rock-like material in manufacture of a physical model allows for more accurate simulation of the behavior of rock in a subterranean region. Typically, properties of material in a subterranean region are often estimated based on laboratory testing of a core extracted from the region. However, the repeatability of test results can be compromised, as there often are significant variations as a borehole extends through a region due to, for example, porosity, fracture properties, anisotropy, heterogeneity and other micro-structural details. Embodiments described herein provide a solution to this problem by providing synthetic models that are created from materials that approximate the properties of downhole material (rock), and that exhibit structural variations expected to be encountered downhole (e.g., as a borehole is drilled). In addition, properties of the model can be digitally controlled or changed, allowing for ease of producing models for analysis.

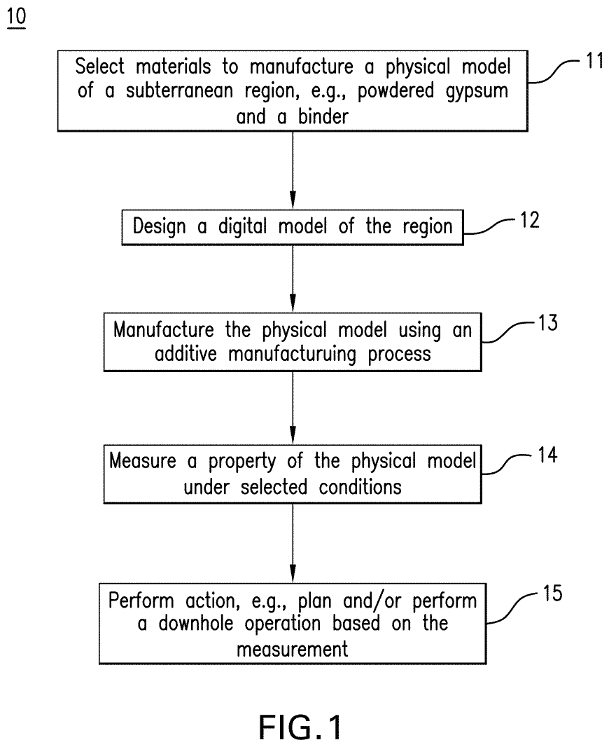

FIG. 1 depicts an embodiment of a method 10 of manufacturing a synthetic physical model of a subterranean region, and/or estimating or measuring a property or properties of the physical model. The property or properties may be estimated by performing various measurements of the physical model under selected conditions, such as conditions that correspond to downhole conditions encountered at a borehole.

The method 10 includes a number of stages, aspects of which are represented by blocks 11-15. The stages may be performed in the order described, or one or more stages may be performed in a different order. In addition, the method 10 may include fewer than all the stages. All or part of the method may be performed by a processing device, an operator, or an operator in conjunction with a processing device.

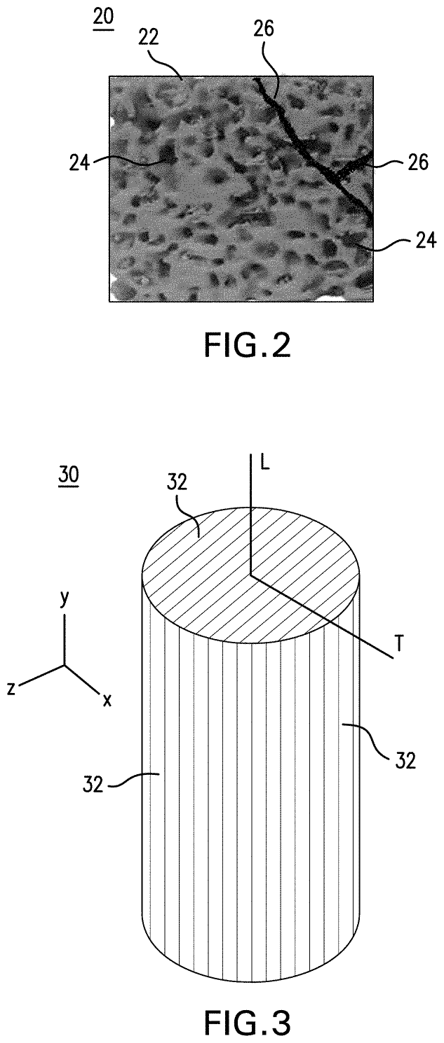

The method 10 is discussed in conjunction with an example of a portion of a physical model 20 manufactured according to the method 10, and having structural features shown in FIG. 2. This example is provided for illustration purposes, and is not intended to limit the method 10.

At block 11, materials are selected that will be used to manufacture a physical model of a subterranean region. The materials may be selected to approximate various mechanical properties, such as strength, toughness, stiffness, and elastic properties.

Any of various materials can be used to create the model and approximate mechanical and structural properties of subterranean materials. Such materials are referred to herein as “model materials,” and are selected to approximate mechanical properties of rock that make up the structure of a subterranean region, such as sandstone, granite, shale and others.

In an embodiment, the model materials include a mineral material (e.g., a single mineral or combination of minerals) selected to, when incorporated into the physical model, have mechanical properties that approximate (e.g., are the same as or similar to) mechanical properties of rock material found downhole. As described herein, the model “approximates” a selected property when a corresponding property of the physical model is within a desired range of the selected mechanical property. For example, mechanical properties are selected to approximate the elastic modulus (e.g., Young's modulus, shear modulus, bulk modulus, etc.), strength and/or toughness of rock materials encountered when drilling a borehole, or rock materials that are expected to be encountered.

Examples of suitable mineral materials include gypsum, silica, dolomite, ceramics, carbonates and combinations thereof. In an embodiment, the mineral material is in a granular form. For example, a selected mineral material includes a mineral powder, which can be deposited with a binder as part of a 3D printing or additive manufacturing process. It is noted that the granular material may be a single mineral, multiple minerals, or a combination of a non-mineral materials with one or more minerals.

For example, the model material includes a granular or powdered gypsum material and a binding material (i.e., a binder). Characteristics of the model material are selected, such as grain size, mineral content and the type of binder, based on desired mechanical properties.

Although the method 10 is described as utilizing minerals in the model materials, the method 10 is not so limited. Any suitable material or combination of materials may be selected (in place of or in combination with a mineral or minerals) to approximate selected mechanical properties, such as metals, polymers, and others.

At block 12, a digital model is generated to select dimensions, features and structural properties of the physical model. The digital model may specify geometric properties, such as the overall size and dimensions. The structural properties include, for example, pore structure (e.g., pore size and density), pore geometry and/or fracture structure (e.g., fracture length, fracture width, fracture orientation, the number and relative locations of multiple fractures in a fracture network). In addition, the digital model may specify material properties, such as the type of granular material and binder, and the density of granular material deposited in each layer.

The digital model may be constructed using any suitable data structure, software and/or processing device. In an embodiment, a computer-aided drafting (CAD) program is used to create a three-dimensional digital model, which is subsequently employed in a 3D-printing technique or other process to construct a physical model having the characteristics and properties specified by the digital model. It is noted that embodiments described herein are not limited to CAD modelling or any specific program or technique for creating a virtual or digital representation of an object or design.

In an embodiment, the digital model of a region is designed to have structural properties that include a selected porosity or range of porosities and pore features (e.g., pore size, pore density and/or pore geometry), and may be designed to include fractures or other heterogeneities if desired. Other features that may be incorporated into the model include model layers having different properties, and fractures that have selected lengths, orientations and widths, or a pre-designed fracture network.

The physical model may have a cylindrical or other elongated shape that approximates the shape and size of a core sample (or have any other desired shape), with one or more properties (e.g., porosity) that vary along one or more directions. Properties and/or structural features may be varied along one or more axes or directions, such as the direction of a longitudinal axis of the physical model, and/or any other axis or direction. For example, the physical model may have a porosity that increases along a longitudinal axis of the physical model (e.g., to approximate sandstone or other rock material encountered by a vertical borehole section), or along an axis at least partially orthogonal to the longitudinal axis (e.g., to approximate rock material encountered by a horizontal or deviated borehole section).

In one embodiment, the digital model is designed to have a variation in microstructural properties or features. For example, micro-scale or pore-scale properties such as pore size, pore distribution, pore geometry and microcrack properties may be varied along one or more selected directions, or varied by model layer. Other properties that can be varied include fracture or fracture network characteristics and/or any other structural heterogeneities.

FIG. 2 depicts an example of microstructural properties that can be incorporated into the physical model. FIG. 2 illustrates a cross-section of a portion of an example of a model 20 in the micro-scale (e.g., 100 microns or less). A gypsum-based material 22 made from gypsum powder and a binder was additively manufactured to have micro-scale pores 24 that are within a selected pore size range (e.g., about 10-100 microns). The pore size and distribution in the model were at least partially randomly distributed. In addition to the pores 24, other microstructures including microcracks 26 were incorporated into the physical model via the digital model.

As shown, the ability to model a region digitally in the micro-scale allows for the design of asymmetrical pore structure, as well as fractures or cracks that may vary in thickness and direction.

In an embodiment, the physical model is configured to exhibit anisotropy and/or orthotropy by varying a model property among the multiple individual layers deposited during a 3D printing process. For example, the model includes a plurality of model layers (planar regions) that are parallel to a given axis or plane, and the properties of each model layer are selected to define a distribution of properties among the model layers in a direction orthogonal to the axis or plane. The distribution may be selected to simulate the change in property of a material along an axis (e.g., depth or axis of borehole) to simulate changes in the property as a function of depth or as a function of position along a borehole.

The distribution may also be selected to simulate formation layers, such as bedding layers having different rock materials and/or properties such as porosity. This may be accomplished by keeping a model property consistent within each model layer, but varying the model property between one or more model layers.

As is known in the art, anisotropy is found when the value of a vector measurement of a material property varies with direction. Anisotropy can be imparted, as noted above, by constructing model layers that have different properties (e.g., porosity, pore structure, fracture properties, mechanical properties such as strength, and others).

Model properties can be controlled or selected by selecting properties of the model material. In embodiments in which a granular material and bonder are used, mechanical properties such as strength and elastic properties can be selected by selecting the type of granular material, the size of granular material (grain size), and/or the density of the granular material used to form a model layer or other portion. Mechanical properties can also be selected by selecting the mineral content of the granular material and/or by selecting the type of binder.

The physical model may be constructed to be isotropic or anisotropic in various directions. For example, the model is constructed to have vertically transverse isotropy (VTI), tilted transverse isotropy (TTI) or horizontal transverse isotropy (HTI).

The physical model may be configured to exhibit various forms of anisotropy. Examples include seismic or acoustic anisotropy, resistive anisotropy, magnetic anisotropy, and permeability isotropy. Seismic anisotropy is dependent on, among others, mineral alignment, layering and fracturing. Variation in properties can thus be accomplished in various directions to simulate anisotropy.

At block 13, the model is manufactured using a technique capable of reproducing the structural features of the digital model.

In an embodiment, the manufacturing technique is an additive manufacturing or 3D-printing technique, in which individual layers are successively deposited to gradually build up the structure specified by the digital model. For example, each layer is built by depositing a layer of gypsum powder and selectively spraying or otherwise adding a binder to the layer. The layers are successively added to form a printed body having the dimensions and structural characteristics of the digital model. Any of various 3D printing can be used, such as inkjet, material extrusion, and powder bed technologies. In an embodiment, the model is constructed via a binder jetting powder bed process in which, for each successive layer, a layer of powder is deposited on a 3D printer platform, a binder is sprayed on the powder layer to solidify areas of the powder layer according to the digital model. The process also includes removal of powder that was not solidified, and may also include a curing step.

Manufacturing may be performed using a technique that involves deposition of individual layers of a material. It is noted that the term “individual layer” refers to a single layer of material deposited during additive manufacturing. A “model layer” refers to a section of a constructed model, which may be constructed by depositing a plurality of individual layers.

At block 14, one or more environmental conditions are applied to the completed physical model, and measurements are performed on the physical model under the applied conditions. Examples of applied conditions include pressure, temperature and fluid conditions, such as the type of hydrocarbon and/or non-hydrocarbon fluid or gas present in a region.

The environmental conditions may be selected to approximate or simulate conditions in a downhole environment. For example, the physical model is subjected to a temperature or temperature range and/or a pressure or pressure range that is known or expected to be found in a downhole environment.

In other example, the physical model is disposed in a fluid environment or one or more fluids are injected into the sample or flowed through the sample. For example, water and/or a hydrocarbon fluid (e.g., natural gas or light oil) is injected into the physical model. The behavior of fluid in the model can be measured in order to understand fluid mechanics in the model.

The printed physical model can then be tested under controlled conditions in order to evaluate a subterranean region and/or calibrate a computer model or measurements of the region. For example, the physical model can be subjected to temperatures and/or pressures known or expected to be found downhole as a result of a downhole operation, and/or fluid can be injected or flowed into the physical model to simulate fluid composition and to evaluate how fluid flows therethrough.

Mechanical testing may be performed on the physical model, such as strength testing and/or testing for elastic properties. For example, elastic properties such as Young's modulus, bulk modulus, shear modulus, and/or Poisson's ratio can be estimate based on seismic or acoustic measurements. Elastic properties can be measured for isotropic-specific or VTI-specific properties (e.g., 5-elastic properties relevant for layered rocks like shale gas), or orthotropic-specific properties (e.g., 9-elastic properties.

For example, the physical model is disposed in a laboratory environment, and downhole environmental conditions are applied to the model. Sets of acoustic transducers are positioned with respect to surfaces or planes of isotropy and held proximate to the model. Acoustic velocity measurements are then performed and an elasticity value of the core under various conditions can be derived.

Other measurements include applying a drill bit or other cutting device to the physical model to study cutter-rock interaction, and other properties such as pressure dependent frictional properties. Such measurements can be used to evaluate cutter reliability and durability in a given geological condition.

At block 15, various actions may be performed based on the measurements. Such actions may include storing and/or transmitting measurement information, and providing evaluations relevant to hydrocarbon exploration and production. Based on the measurements, various actions may be performed, such as calibrating measurements and computer models, planning downhole operations (e.g., drilling, production, well intervention, etc.) and/or controlling parameters of a downhole operation.

As noted above, the physical model may be configured to be isotropic or anisotropic in various directions. For example, the model is constructed to have vertically transverse isotropy (VTI), tilted transverse isotropy (TTI) or horizontal transverse isotropy (HTI).

The physical model may be configured to exhibit various forms of anisotropy. Examples include seismic or acoustic anisotropy, resistive anisotropy, magnetic anisotropy, and permeability isotropy. Seismic anisotropy is dependent on, among others, mineral alignment, layering and fracturing. Variation in properties can thus be accomplished in various directions to simulate anisotropy.

In an embodiment, anisotropy is provided by varying properties such as elastic Young's modulus E (ratio of axial stress to axial strain) and/or Poisson's ratio v (ratio of radial strain to axial strain.

For example, weight fractions of minerals (mineral constituents) in the model material are selected, along with the volume fraction that is controlled by selecting porosity properties (pore size). For example, the mineral content and porosity is controlled for each layer, such that one or more layers have a different mineral content and/or porosity.

The porosity of a given layer may be selected to exhibit desired a desired bulk modulus K. The bulk modulus K may include bulk modulus (Kb), and the weight fraction of minerals in a given layer is selected to have a desired grain matrix modulus Kma. The moduli Kb and Kma are elastic moduli under hydrostatic confinement following Hooke's law.

In addition to controlling porosity (e.g., pore size and geometry) along one or more axes, the mineral content of the model material may be selected and/or varied to simulate rock mechanical properties as a function of minerology. In an embodiment, the minerology is varied using Voight and Reuss averaging algorithms as upper and lower bounds. For example, the weight fraction of minerals having known shear and bulk moduli are selected to define an upper bound bulk modulus (Voight average) and a lower bound bulk modulus (Reuss average).

Anisotropy may be exhibited as a function of various properties of a model. For example, isotropy can be defined structurally as a variation in porosity, pore geometry, etc. In another example, electrical anisotropy (conductivity in one direction (e.g. parallel to a layer), is different from that in another (e.g. perpendicular to a layer). Resistivity can be affected by varying porosity.

Anisotropy may be expressed in relation to bedding layers in a subterranean region, such as a hydrocarbon bearing formation. Transverse anisotropy refers to anisotropy in a direction perpendicular to planes of isotopy, such as formation layers or boundaries.

One type of anisotropy corresponds to a material with aligned vertical weaknesses such as cracks or fractures, or with unequal horizontal stresses. Elastic properties vary in the direction crossing the fractures, but not along the plane of the fracture. Such a material is called transversely isotropic with a horizontal axis of symmetry (TIH). Waves traveling along the fracture direction generally travel faster than waves crossing the fractures. Identifying and measuring this type of anisotropy yield information about rock stress, fracture density and fracture orientation.

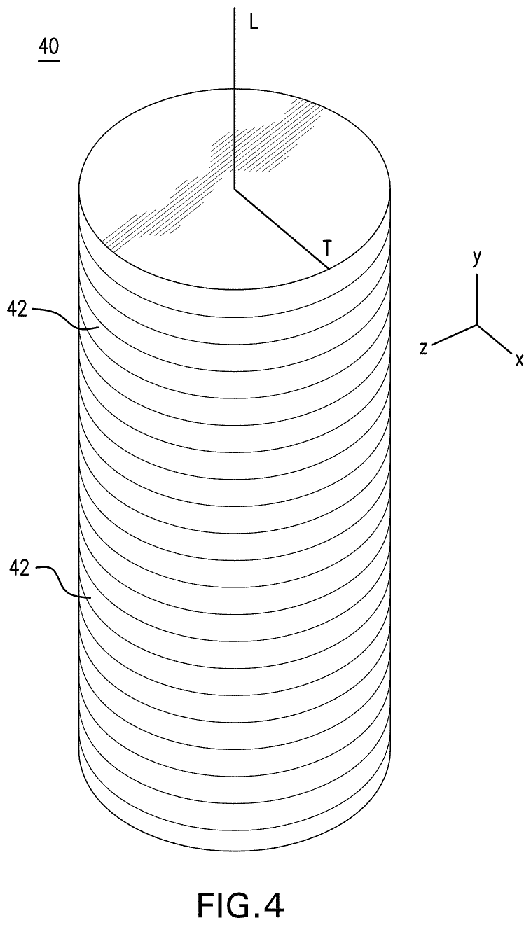

FIG. 3 depicts an example of a physical model 30 constructed according to the method 10. In this example, the physical model is a cylindrical structure designed to mimic the size and shape of a core sample. The physical model is represented in a three-dimensional space defined by axes x, y and z. In this example, the model has a longitudinal axis L, parallel to the z-axis, and a transverse axis T parallel to the x-axis.

The physical model 30 in this example is constructed to define a plurality of layers 32 that simulate, for example, bedding layers of an unconventional shale formation. The layers are parallel to the longitudinal axis L, and each layer is designed to have a selected porosity. The model 30 in this example simulates a core a core or plug extracted in a direction parallel to shale bedding layers. The model 30 is printed using powdered gypsum in combination with a binder to deposit layers in a plane parallel to the longitudinal axis L to simulate a shale formation. The layers are deposited so that the porosity and/or mineral content increases or decreases among the bedding layers. Thus, elastic properties are non-symmetrical along the transverse axis T. Such a material is called transversely isotropic with a vertical axis of symmetry (TIV).

FIG. 4 shows another example of a physical model 40, which includes a plurality of horizontal layers 42. In this example, the deposited layers 42 simulate bedding layers (e.g., by varying porosity and/or mineral content among the layers) and/or fractures to result in transverse isotropy with a horizontal axis of symmetry.

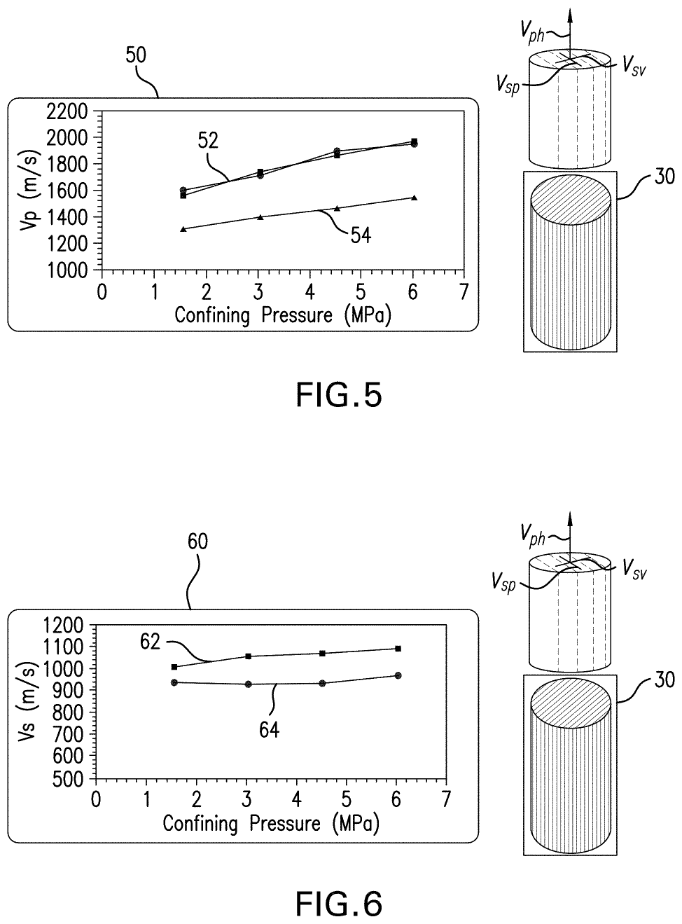

FIGS. 5 and 6 show examples of anisotropic properties of the physical model 30. The physical model has a cylindrical shape, i.e., the shape of a core, with overall dimensions are 1.5″ in radius (along the transverse axis T) and 3.0″ in height (along the longitudinal axis L). The overall mass is 124.8 g, the bulk density (dry) is 1.44 g/cc, and the overall porosity (dry) is about 34%. The model layers 32 are parallel to the axis L.

Seismic or acoustic anisotropy was measured by applying ultrasonic waves to the model 30. For propagation perpendicular to the model layers 32 (simulated bedding layers), there are vertically propagating compressional waves having velocity V_{PV}, and vertically propagating shear waves having velocity V_{SV}. For propagation parallel to the model layers 32, there are horizontally propagating compressional waves having velocity V_{PH}, and shear waves V_{SV} having velocity.

The velocity of compressional waves (V_{P}) and the velocity of shear waves (V_{S}) were measured parallel to the axis L, perpendicular to the axis L, and radially. The average compressional wave velocity V_{P} had an average of about 1.96 km/s (vertical), and an average of about 1.55 km/s (horizontal) km/s. The average shear wave velocity V_{S} had an average of about 1.07 km/s (vertical), and average of about 0.93 km/s (horizontal). The average Young's Modulus was about 3.02 GPa (vertical) and about 4.22 GPa (horizontal). The average Poisson's ratio was about 0.22 (vertical) and about 0.29 (horizontal).

FIG. 5 includes a graph 50 of V_{P} as a function of confining pressure (2-6 MPa). V_{P} anisotropy was well captured, as demonstrated by curves 52 and 54. As shown, V_{PH} ranged from about 1600 to about 1968 m/s, and V_{PV} ranged from about 1313-154668 m/s.

FIG. 6 demonstrates V_{S} anisotropy, and includes a graph 60 of V_{S} as a function of confining pressure (2-6 MPa). V_{S} anisotropy was well captured, as demonstrated by curves 62 and 64. As shown, V_{SH} ranged from about 1007 to about 1090 m/s, and V_{SV} ranged from about 937 to about 971 m/s.

It is understood that one or more embodiments described herein is capable of being implemented in conjunction with any suitable type of computing environment now known or later developed.

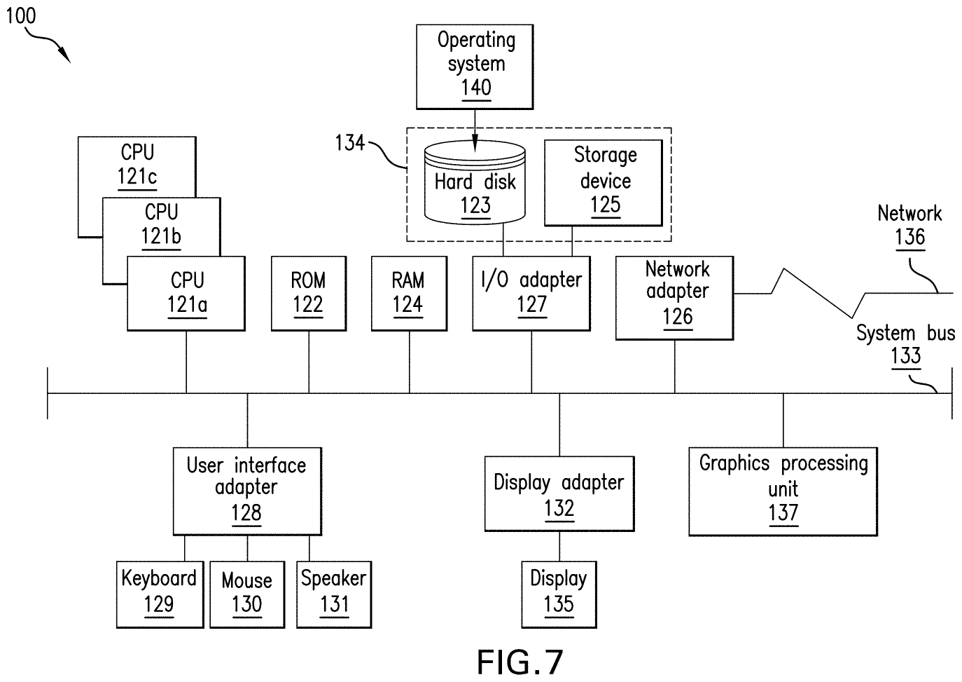

FIG. 7 is a block diagram of a processing system 100 for performing one or more methods described herein. For example, the processing system may be configured to control aspects of designing a physical model, performing additive manufacturing, measurements of a physical model and/or other techniques described herein.

The processing system 100 has one or more central processing units (“processors” or “processing resources”) 121a, 121b, 121c, etc. (collectively or generically referred to as processor(s) 121 and/or as processing device(s)). The processors 121 are coupled to system memory (e.g., random access memory (RAM) 124) and various other components via a system bus 133. Read only memory (ROM) 122 is coupled to the system bus 133 and may include an input/output (I/O) system.

The processing system 100 includes an I/O adapter 127 and a network adapter 126 coupled to the system bus 133. The I/O adapter 127 may communicate with a system memory 134 including a hard disk 123 and/or a storage device 125. An operating system 140 is included for execution on processing system 100, and may be stored in the system memory 134. The network adapter 126 interconnects the system bus 133 with an outside network 136.

A display (e.g., a display monitor) 135 is connected to the system bus 133 by the display adapter 132, which may include a graphics adapter to improve the performance of graphics intensive applications (e.g., CAD applications) and a video controller. Additional input/output devices may be included, such as a user interface adapter 128 and display adapter 132. A keyboard 129, mouse 130, and speaker 131 may be interconnected to the system bus 133 via the user interface adapter 128.

The processing system 100 may include a graphics processing unit 137. The graphics processing unit 137 may be a specialized electronic circuit designed to manipulate and alter memory to accelerate the creation of images in a frame buffer intended for output to a display.

Set forth below are some embodiments of the foregoing disclosure:

Embodiment 1: A method of estimating a property associated with a subterranean region, the method comprising: acquiring a synthetic physical model of the subterranean region, the physical model made from at least a mineral material and constructed using an additive manufacturing process, the physical model having a microstructure, the microstructure having a parameter that varies along at least a first axis of the physical model; performing a measurement of the physical model under an applied condition; and estimating the property of the subterranean region based on the measurement.

Embodiment 2: The method of any prior embodiment, wherein the mineral material is a granular material, and the physical model is made from the granular material and a binder.

Embodiment 3: The method of any prior embodiment, wherein the mineral material includes gypsum.

Embodiment 4: The method of any prior embodiment, wherein the microstructure parameter is varied along at least one axis to impart anisotropy to the physical model.

Embodiment 5: The method of any prior embodiment, wherein the anisotropy is selected from at least one of transverse isotropy and orthotropy.

Embodiment 6: The method of any prior embodiment, wherein the microstructure is a porous microstructure having a selected porosity, and the microstructure parameter includes at least one of a pore size, a material parameter and a parameter of one or more microfractures.

Embodiment 7: The method of any prior embodiment, wherein the physical model includes a plurality of planar regions, each planar region extending along a second axis, the second axis perpendicular to the first axis.

Embodiment 8: The method of any prior embodiment, wherein each planar region of the plurality of planar regions is isotropic.

Embodiment 9: The method of any prior embodiment, wherein the physical model is configured to simulate bedding regions of the subterranean region, the bedding regions exhibiting transverse isotropy.

Embodiment 10: The method of any prior embodiment, wherein the microstructure includes one or more microfractures, the one or more microfractures configured to impart isotropy to the physical model.

Embodiment 11: A method of manufacturing a physical model of a subterranean region, the method comprising: acquiring model materials including at least a mineral material; designing a digital model of the subterranean region, the digital model specifying a microstructure having a parameter that varies along at least a first axis of the digital model; and constructing the physical model by an additive manufacturing process according to specifications of the physical model.

Embodiment 12: The method of any prior embodiment, wherein the model materials include a granular mineral material and a binder.

Embodiment 13: The method of any prior embodiment, wherein the mineral material includes gypsum.

Embodiment 14: The method of any prior embodiment, wherein the microstructure parameter is varied along at least one axis to impart anisotropy to the physical model.

Embodiment 15: The method of any prior embodiment, wherein the anisotropy is selected from at least one of transverse isotropy and orthotropy.

Embodiment 16: The method of any prior embodiment, wherein the microstructure is a porous microstructure having a selected porosity, and the microstructure parameter includes at least one of a pore size, a material parameter and a parameter of one or more microfractures.

Embodiment 17: The method of any prior embodiment, wherein the physical model includes a plurality of planar regions, each planar region extending along a second axis, the second axis perpendicular to the first axis.

Embodiment 18: The method of any prior embodiment, wherein each planar region of the plurality of planar regions is isotropic.

Embodiment 19: The method of any prior embodiment, wherein the physical model is configured to simulate bedding regions of the subterranean region, the bedding regions exhibiting transverse isotropy.

Embodiment 20: The method of any prior embodiment, wherein the microstructure includes one or more microfractures, the one or more microfractures configured to impart isotropy to the physical model.

In support of the teachings herein, various analysis components may be used, including a digital and/or an analog system. For example, embodiments such as the system 10, downhole tools, hosts and network devices described herein may include digital and/or analog systems. Embodiments may have components such as a processor, storage media, memory, input, output, wired communications link, user interfaces, software programs, signal processors (digital or analog), signal amplifiers, signal attenuators, signal converters and other such components (such as resistors, capacitors, inductors and others) to provide for operation and analyses of the apparatus and methods disclosed herein in any of several manners well-appreciated in the art. It is considered that these teachings may be implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first,” “second” and the like do not denote a particular order, but are used to distinguish different elements.

While one or more embodiments have been shown and described, modifications and substitutions may be made thereto without departing from the spirit and scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed:

1. A method of estimating a property associated with a subterranean region, the method comprising:
acquiring a synthetic physical model of the subterranean region, the physical model made from at least a mineral material and constructed using an additive manufacturing process, the physical model having a microstructure, the microstructure having a parameter that varies along at least a first axis of the physical model;
performing a measurement of the physical model under an applied condition; and
estimating the property of the subterranean region based on the measurement.

2. The method of claim 1, wherein the mineral material is a granular material, and the physical model is made from the granular material and a binder.

3. The method of claim 1, wherein the mineral material includes gypsum.

4. The method of claim 1, wherein the microstructure parameter is varied along at least one axis to impart anisotropy to the physical model.

5. The method of claim 4, wherein the anisotropy is selected from at least one of transverse isotropy and orthotropy.

6. The method of claim 1, wherein the microstructure is a porous microstructure having a selected porosity, and the microstructure parameter includes at least one of a pore size, a material parameter and a parameter of one or more microfractures.

7. The method of claim 6, wherein the physical model includes a plurality of planar regions, each planar region extending along a second axis, the second axis perpendicular to the first axis.

8. The method of claim 7, wherein each planar region of the plurality of planar regions is isotropic.

9. The method of claim 8, wherein the physical model is configured to simulate bedding regions of the subterranean region, the bedding regions exhibiting transverse isotropy.

10. The method of claim 1, wherein the microstructure includes one or more microfractures, the one or more microfractures configured to impart isotropy to the physical model.

11. A method of manufacturing a physical model of a subterranean region, the method comprising:
acquiring model materials including at least a mineral material;
designing a digital model of the subterranean region, the digital model specifying a microstructure having a parameter that varies along at least a first axis of the digital model; and
constructing the physical model by an additive manufacturing process according to specifications of the physical model.

12. The method of claim 11, wherein the model materials include a granular mineral material and a binder.

13. The method of claim 11, wherein the mineral material includes gypsum.

14. The method of claim 11, wherein the microstructure parameter is varied along at least one axis to impart anisotropy to the physical model.

15. The method of claim 14, wherein the anisotropy is selected from at least one of transverse isotropy and orthotropy.

16. The method of claim 11, wherein the microstructure is a porous microstructure having a selected porosity, and the microstructure parameter includes at least one of a pore size, a material parameter and a parameter of one or more microfractures.

17. The method of claim 16, wherein the physical model includes a plurality of planar regions, each planar region extending along a second axis, the second axis perpendicular to the first axis.

18. The method of claim 17, wherein each planar region of the plurality of planar regions is isotropic.

19. The method of claim 18, wherein the physical model is configured to simulate bedding regions of the subterranean region, the bedding regions exhibiting transverse isotropy.

20. The method of claim 11, wherein the microstructure includes one or more microfractures, the one or more microfractures configured to impart isotropy to the physical model.
